(19) United States
(12) Patent Application Publication
(10) Pub. No.: US 2003/0080737 A1
(43) Pub. Date: May 1, 2003

(54) Method for generating image data by means of magnetic resonance

(76) Inventor: Ralf Loeffler, Wurzburg (DE)

Correspondence Address: SCHIFF HARDIN & WAITE, 6600 SEARS TOWER, 233 S WACKER DR, CHICAGO, IL, 60606-6473, US

(21) Appl. No.: 10/256,417

(22) Filed: Sep. 27, 2002

(30) Foreign Application Priority Data
Sep. 28, 2001 (DE) 101 47 919.0

(51) Int. Cl. G01V 3/00

(52) U.S. Cl. 324/307; 324/309

(57) ABSTRACT

In a method for generating image data by means of magnetic resonance radio-frequency excitation pulses and magnetic gradient pulses are emitted into an imaging region for generating location-coded magnetic resonance signals, which are received with an antenna for filling a k-space dataset that is divided into a low-frequency region and a higher-frequency region of k-space rows. The k-space rows are more densely arranged in the low-frequency region than in the higher-frequency region. The higher-frequency region is filled with synthetic k-space rows in post-processing such that the row density in the filled, higher-frequency region is the same as the row density in the low-frequency region. Image data of the imaging region are generated from the k-space dataset with the low-frequency region and the filled higher-frequency region using a Fourier transformation.

### BACKGROUND OF THE INVENTION

1. Field of the Invention

The present invention is directed to a method for generating image data using magnetic resonance, and in particular to such a method wherein the data acquisition time is reduced.

2. Description of the Prior Art

Magnetic resonance technology is used for generating images of the inside of an examination subject. Magnetic resonance imaging has become widespread in medicine because tomograms from the inside of the body with a high soft part contrast can be produced therewith without radiation stress. For image generation, the examination subject is exposed to a static basic magnetic field and rapidly switched magnetic gradient fields in a magnetic resonance apparatus. For exciting magnetic resonance signals, radio-frequency signals are emitted into the examination subject. The excited magnetic resonance signals are location coded in frequency and phase by means of the magnetic gradient fields, and are then received. The received magnetic resonance signals are emitted into a k-space dataset in conformity with the location coding. Finally, the image data are reconstructed from the k-space data by means of a Fourier transformation.

Primarily, fast Fourier transformation algorithms are currently employed, operating on a Cartesian grid in k-space as well as in the image domain. The advantage of these algorithms is that the reconstruction can occur very fast. Moreover, the imaging behavior of this transformation is well known.

Continuing technical development of the components of magnetic resonance apparatus and the introduction of fast imaging sequences have opened more fields of employment in medicine for magnetic resonance imaging. Real-time imaging for supporting minimally invasive surgery, functional imaging in neurology and perfusion measurement in cardiology are only a few examples. Despite the technical advances made in the construction of magnetic resonance apparatus, the exposure time for obtaining a magnetic resonance image remains the limiting factor for many applications in medical diagnostics. A further increase in the performance of magnetic resonance apparatus is limited from a technical point of view (practical apparatus construction) and for reasons of patient protection (stimulation and tissue heating). Therefore there have been numerous efforts in recent years to develop and establish new approaches in order to achieve further shortening of the image measurement time.

One approach for shortening the acquisition time is to reduce the quantity of image data to be registered. In order to obtain a complete image from such a reduced dataset, either the missing data must be reconstructed with suitable algorithms or the faulty image from the reduced data must be corrected.

One measuring method with which the measurement time can be shortened in magnetic resonance imaging is described in the article by Peter M. Jakob, Mark A. Griswold, Robert R. Edelman, Daniel K. Sodickson, “AUTO-SMASH: A self-calibrating technique for SMASH imaging”, which appeared in Magnetic resonance Materials in Physics, Biology and Medicine, 1988, volume 7, pages 42-54. This method is one of the parallel acquisition (PPA) methods wherein k-space is only incompletely sampled in the phase-coding direction. A number of antennas are thereby employed for the reception, these respectively receiving magnetic resonance signals from only a part of the imaging region. The missing k-space rows are then synthesized from the received signals by means of a weighted addition, with the weighting factors being determined from one or more additionally measured k-space rows that are referred to as self-calibrating signals in this article. A disadvantage of method is that multiple radio-frequency antennas must be employed.

Another method for shortening the measurement time is described in the article by Paul Margosian, Franz Schmitt, David Purdy, “Faster MR Imaging: Imaging with Half the Data”, which appeared in Health Care Instrumentation, Vol. 1, No. 6, pages 195-197, 1986. In this method, only half of k-space is filled with measured signals; the missing signals are determined from the measured signals via symmetry properties of k-space. Since only half of the overall data need be measured in this method, this method also is called half-Fourier method.

### SUMMARY OF THE INVENTION

An object of the present invention is to provide a method for generating image data by means of magnetic resonance with reduced measurement time.

The object is achieved in accordance with the invention in a method having the steps of transmitting radio-frequency excitation pulses and magnetic gradient pulses into an imaging region for generating location-coded magnetic resonance signals, receiving the magnetic resonance signals with an antenna for filling a k-space dataset that is divided into a low-frequency and a higher-frequency region with k-space rows, whereby the k-space rows are more densely arranged in the low-frequency region than in the higher-frequency region, filling the higher-frequency region with synthetic k-space rows in post-processing such that the row density in the filled, higher-frequency region is the same as the row density in the low-frequency region, and generating image data of the imaging region from the k-space dataset with the low-frequency region and the filled higher-frequency region using a Fourier transformation.

Differing from the known PPA methods, the inventive method makes it possible to save significant measurement time even with employment of only one radio-frequency antenna. Due to the filling of the missing data, fast Fourier transformation algorithms can thereby be utilized despite the non-uniform occupancy of the k-space with measured data. Nonetheless, the artifacts due to the incomplete occupation of the outer k-space region are negligible as long as the middle, completely filled k-space region does not become too small.

A correct, although complicated, type of interpolation in a first exemplary embodiment of the invention is to form the synthetic k-space rows from the higher-frequency k-space rows with a sinc-interpolation.

In another embodiment the synthetic k-space rows are filled with zero values. This method is distinguished by its simplicity, but the middle, completely filled region of the k-space must not become too small, in order to avoid visible artifacts.

In another embodiment, only one half of k-space is filled with k-space rows, and the k-space rows of the corresponding, other half are determined from these k-space rows according to the half-Fourier method.

In an especially advantageous embodiment, the radio-frequency pulses and the gradient pulses are controlled according to a fast gradient echo method. These inherently fast sequences allow a further shortening of the measurement time.

### DESCRIPTION OF THE DRAWINGS

FIG. 1 is a block circuit diagram of a diagnostic magnetic resonance apparatus that is operated according to the inventive method.

FIG. 2 is a flowchart of the basic steps of an exemplary embodiment of the inventive method.

FIG. 3 illustrates a fast measuring sequence that is controlled in the phase-coding direction according to the inventive method.

### DESCRIPTION OF THE PREFERRED EMBODIMENTS

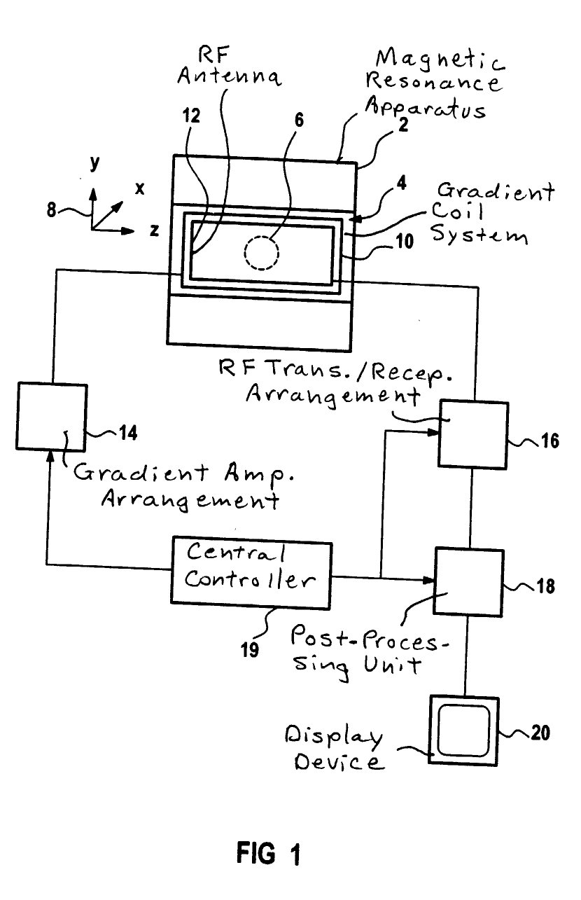

The present invention for generating image data by means of magnetic resonance is explained as an example below in the context of its application in a diagnostic magnetic resonance apparatus. Since the structure of a diagnostic magnetic resonance apparatus is well-known, the illustration in FIG. 1 is limited to the basic components. A magnetic resonance apparatus 2 is schematically shown, with a body region or a patient to be examined in the imaging being displaced in the examination space 4 thereof. The actual imaging region is located in the homogeneous region 6 of a strong, static basic magnetic field. The mid-point of the homogeneous field region 6 simultaneously defines the mid-point of a rectangular xyz-coordinate system 8 that, however, is shown outside the diagnostic magnetic resonance apparatus 2 for clarity. The z-direction coincides with the symmetry axis of the examination space and also coincides with the field direction of the basic magnetic field.

The diagnostic magnetic resonance apparatus 2 further has a gradient coil system 10 for generating mutually independent gradient fields in the coordinate directions x, y and z. Further, a radio-frequency antenna 12 is provided for the excitation and the reception of the magnetic resonance signals.

The gradient coil system 10 is connected to a gradient amplifier arrangement 14 that makes the time-variable currents available for generating the magnetic gradient fields.

The radio-frequency antenna 12 is connected to a radio-frequency transmission/reception arrangement 16 that generates the radio-frequency excitation signals and outputs them to the radio-frequency antenna 12 and also amplifies the received magnetic resonance signals, converts them into digital signals, and forwards the digital signals to a post-processing unit 18. In the post-processing unit 18, image data that can be reproduced on a display device 20 are generated, using a fast Fourier transformation, from the magnetic resonance signals that are location-coded with the magnetic gradient fields.

The gradient amplifier arrangement 14, the radio-frequency transmission/reception arrangement 16 and the post-processing unit 18 are activated and controlled by a central controller 19 in the form of a programmed computer, dependent on the measurement sequences that have been set. The controller 19 is configured here so that the magnetic resonance signals are generated location-coded according to the method described below, and then are edited for the imaging in the post-processing unit 18.

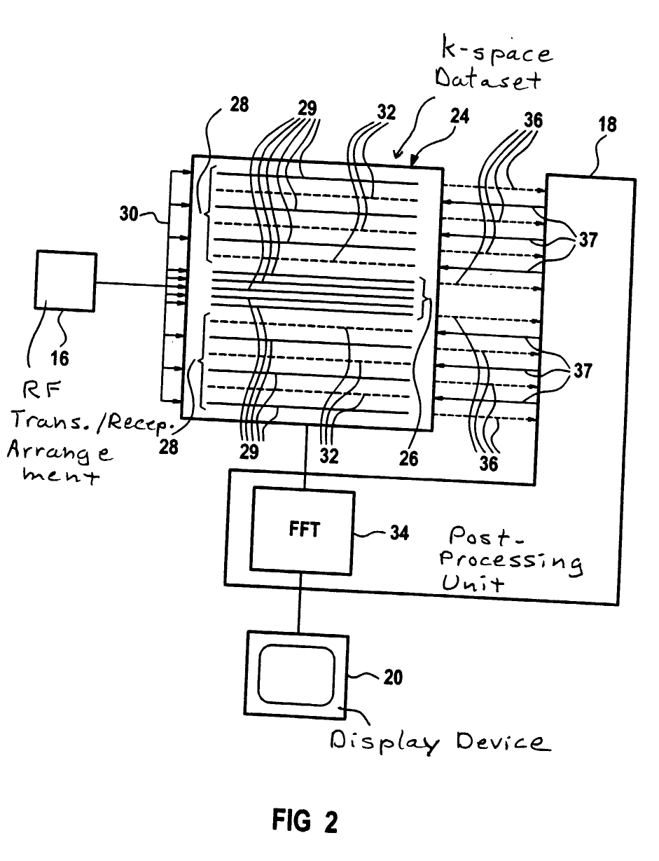

FIG. 2 schematically shows a k-space dataset 24 that is filled with digitalized magnetic resonance signals such that the magnetic resonance signals are frequency-coded in the row direction and phase-coded in the column direction. In the phase-coding direction, the k-space dataset is subdivided into a low-frequency, middle region 26 and a higher-frequency, outer region 28. According to a first step of the inventive method, the phase coding of the magnetic resonance signals ensues such that the k-space rows in the low-frequency region 26 are more densely arranged than in the higher-frequency region 28. This is illustrated in FIG. 2 with an arrow group 30. The higher-frequency region 28 is filled with synthetic k-space rows 32 so that the row density in the higher-frequency region 28 is equal to the row density in the low-frequency region 26. The k-space dataset 24 thus is completely occupied, so that the image data for the display device 20 can be reconstructed with fast Fourier transformation algorithms 34.

In a first embodiment, the synthetic k-space rows 32 are formed in the post-processing unit 18 from the measured k-space rows 29 of the higher-frequency region 28 by means of a sinc-interpolation. The data removal is symbolized with broken-line arrows 36, whereas the data delivery of the synthetic k-space rows 32 is illustrated by arrows 37. This accurate type of interpolation, however, makes use of considerable computing time. To avoid such a long computing time, in a second embodiment the k-space rows instead are filled with zero values in a second embodiment. This data delivery is also illustrated by the arrows 37; data removal as in the first embodiment, however, is not needed here. The image errors that arise in the second embodiment can be accepted when the low-frequency, middle region is selected correspondingly larger.

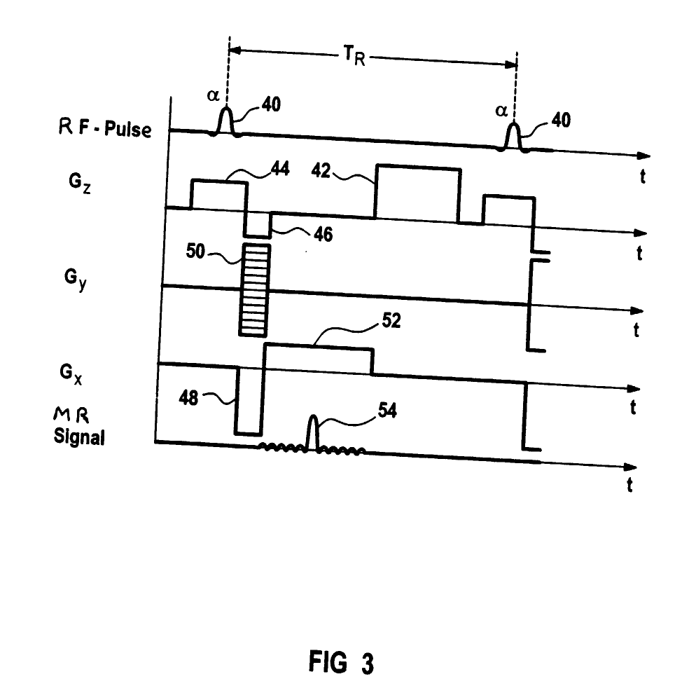

FIG. 3 shows the time curve of a gradient echo sequence—a FLASH sequence here—that is employed for generating the magnetic resonance signals. Gradient echo sequences allow a fast imaging because the repetition time TR for two successive radio-frequency excitation pulses 40 can be selected to be very short. Given the FLASH sequence, thus, the repetition time TR can be lowered to below 0.3 s. The generation of the echo signal ensues by means of gradient repolarization in the slice direction (z-direction here) and readout direction (x-direction here). The cross-magnetization that is still present at the end of the readout interval is destroyed by a pulse referred to as a spoiler pulse 42 in the slice direction.

The excitation of the magnetic resonance signals in a specific slice ensues upon the application of the excitation pulse 40 when a slice gradient pulse 44 is simultaneously activated. The excitation angle a is significantly smaller than 90°, so that an even shorter repetition time TR occurs as a result. For refocusing in the slice direction, the slice selection gradient pulse 44 is followed by a refocusing gradient pulse 46 with half the amplitude-time area of the preceding slice selection gradient 44. Simultaneously with the refocusing pulse 46 in the slice direction, a defocusing in the x-direction occurs with a gradient pulse 48 and a phase coding in y-direction with a gradient pulse 50. A gradient pulse 52 then also is generated for focusing in the slice direction. The magnetic resonance signal 54 that is then received has a maximum approximately in the middle of the gradient pulse 52.

The time-savings that are achieved with the inventive imaging method shall be explained as an example on the basis of a k-space data matrix 24 having a size of 256×256. Overall, only 192 k-space data rows are measured instead of 256 k-space data rows, with every other phase coding step being omitted for filling the outer, high-frequency region in the outer region 28. When a FLASH sequence having a repetition time of 0.3 s is employed for the image data acquisition, a shortening of the measurement time from 256×0.3 s=76.8 s to 192×0.3=57.6 s occurs, i.e. approximately 20 s.

A further shortening of the measurement time can be achieved when half-Fourier techniques are employed, as described in the initially cited article by Margosian et al. Upon application of these techniques, for example, the k-space dataset is filled only with positive phase-coding steps. The negative phase-coding steps then can be determined from the positive phase-coding steps on the basis of symmetry properties of the k-space.

The invention is explained herein on the basis of exemplary embodiments wherein a two-dimensional k-space dataset is determined. The method, however, also can be applied to three-dimensional datasets when the magnetic resonance signals are also phase-coded in the third dimension.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for generating image data by magnetic resonance, comprising the steps of
emitting radio-frequency excitation pulse and magnetic gradient pulses into an image region and thereby generating location-coded magnetic resonance signals;
receiving said location-coded magnetic resonance signals with an antenna and filling a k-space dataset, having a plurality of k-space rows, with the received location-coded magnetic resonance signals;
dividing said k-space dataset into a low-frequency region and a higher-frequency region with said k-space rows being more densely arranged in said low-frequency region than in said higher frequency region;
filling said higher-frequency region with synthetic k-space rows in post-processing so that a row density in the filled, higher-frequency region is the same as a row density in the low-frequency region; and
generating image data of said imaging region from said k-space dataset with said low-frequency region and the filled, higher-frequency region using a Fourier transformation.

2. A method as claimed in claim 1 comprising forming said synthetic k-space rows as a sum of weighted k-space rows in said higher-frequency region.

3. A method as claimed in claim 1 comprising forming said synthetic k-space rows from said k-space rows in said higher-frequency region by a sinc-interpolation.

4. A method as claimed in claim 1 comprising forming said synthetic k-space rows by filling said synthetic k-space rows with zero values.

5. A method as claimed in claim 1 wherein said k-space rows are arranged half as densely in said higher-frequency region than in said low-frequency region, before filling said higher-frequency region with said synthetic k-space rows.

6. A method as claimed in claim 1 comprising filling only a first half of said k-space dataset with said k-space rows, and determining k-space rows for a second half of said k-space dataset from the k-space rows in said first half using a half-Fourier method.

7. A method as claimed in claim 1 comprising controlling said radiofrequency excitation pulses and said magnetic gradient pulses according to a fast gradient echo method.

8. A method as claimed in claim 7 comprising employing a fast low-angle shot sequence (FLASH) as said fast gradient echo method.
